(19) United States
(12) Patent Application Publication
(10) Pub. No.: US 2025/0296089 A1
(43) Pub. Date: Sep. 25, 2025

(54) SAMPLE WELL MIXING SYSTEM AND METHOD

(71) Applicant: DH Technologies Development Pte. Ltd., Singapore (SG)

(72) Inventors: Manuel FAUR, Richmond Hill (CA); Stanislaw POTYRALA, Mississauga (CA); Mikhail KHARKINE, Toronto (CA)

(73) Assignee: DH Technologies Development Pte. Ltd., Singapore (SG)

(21) Appl. No.: 18/864,355

(22) PCT Filed: May 10, 2023
(86) PCT No.: PCT/IB2023/054835

§ 371 Date: Nov. 8, 2024

Related U.S. Application Data
(60) Provisional application No. 63/340,681, filed on May 11, 2022.

(51) Int. Cl. B01L 3/00; B01F 33/3032; B01F 33/452; B01F 35/90; B01F 35/92; B01L 7/00

(52) U.S. Cl. CPC B01L 3/50851; B01F 33/3032; B01F 33/452; B01F 35/90; B01F 35/92; B01L 7/00; B01F 2035/98; B01L 2300/0829; B01L 2300/1894; B01L 2400/043

(57) ABSTRACT

A temperature regulation system for samples in a microplate includes a housing defining an interior volume and first and second airflow ports defined by a first and second exterior surfaces of the housing. The system includes an electromagnetic mixing system that has a base plate defining a plurality of openings, and a plurality of electromagnets. Each electromagnet defines an axis that extends substantially vertically from the base plate. The base plate is disposed in the interior volume and each of the plurality of electromagnets extend toward the first airflow port. A fan is disposed in the interior volume substantially below the base plate. Activation of the fan draws air into the first or second airflow port, substantially parallel to each axis of the plurality of electromagnets, through the plurality of openings, and out of the other of the second and first airflow port.

### CROSS-REFERENCE TO RELATED APPLICATION

This application is being filed on May 10, 2023, as a PCT International Patent Application that claims priority to and the benefit of U.S. Provisional Application No. 63/340,681, filed on May 11, 2022, the disclosure of which is hereby incorporated by reference in its entirety.

### INTRODUCTION

Paramagnetic beads have been used to assist in sample preparation and separation. Conventionally, the beads are introduced into a sample vial with a sample and one or more reagents. The mixture would be mixed, for instance with a magnetic stirrer or an ultrasound mixer. Binding sites on the beads would bond to components or reactants of the mixture. The beads, and bound components, may then be physically separated from the mixture using a permanent magnet. The separated beads may be washed before a release agent releases the bound components for subsequent analysis.

An issue with the conventional method is the need to introduce a magnetic stirrer or ultrasonic mixer into the vial which has the potential to contaminate the sample. The conventional method is also time consuming, leading to increased cost and delay in processing samples.

Magnetic mixing has recently been introduced in conjunction with samples in a sample plate (otherwise referred to as a wellplate or microplate) to mix the samples contained therein as part of analytical processing. Magnetic mixer drive coils generate a substantial amount of heat and, given the size of a conventional sample plate, this will result in a high power density that causes an increase in local temperature within each sample well. Such a temperature increase may have undesired effects on the sample.

### SUMMARY

In one aspect, the technology relates to a temperature regulation system for regulating a temperature of samples in a microplate. The temperature regulation system may include: a housing defining an interior volume, a first airflow port defined by a first exterior surface of the housing, and a second airflow port defined by a second exterior surface of the housing; an electromagnetic mixing system comprising: a base plate defining a plurality of openings; and a plurality of electromagnets each defining an axis and extending substantially vertically from the base plate, wherein the base plate is disposed in the interior volume and wherein each of the plurality of electromagnets extend toward the first airflow port; and a fan disposed in the interior volume substantially below the base plate, wherein activation of the fan draws air into one of the first airflow port and the second airflow port, substantially parallel to each axis of the plurality of electromagnets, through the plurality of openings, and out of the other of the second airflow port and the first airflow port.

In some aspects, the temperature regulation system may include one or more thermal regulation elements for regulating a temperature of the air at a location in the airflow path before the plurality of electromagnets.

In some aspects, the temperature regulation system further includes a plurality of separate airflow passages connected to different subgroups of the plurality of openings, and wherein the system further includes separate fans and/or temperature regulating elements for each of the airflow passages.

In an aspect, the technology relates to a method of regulating a temperature of samples in a microplate. The method may include activating an electromagnetic mixing system comprising: a base plate defining a plurality of openings; and a plurality of electromagnets each defining an axis and extending substantially vertically from the base plate, wherein the base plate is disposed in an interior volume of a housing, wherein the housing defines a first airflow port and a second airflow port, and wherein each of the plurality of electromagnets extend toward the first airflow port; and activating, based on a received signal, a fan disposed in the interior volume substantially below the base plate, wherein activation of the fan draws air into one of the first airflow port and the second airflow port, substantially parallel to each axis of the plurality of electromagnets, through the plurality of openings, and out of the other of the second airflow port and the first airflow port.

In an aspect of the technology a microplate is provided. The microplate may include a top plate comprising an upper surface and a lower surface, wherein: the upper surface defines a plurality of well openings, wherein each well opening of the plurality of well openings is connected to a sample well extending from the lower surface; and the upper surface and the lower surface both define a plurality of airflow openings through the top surface.

In some aspects of the microplate, the plurality of well openings are arranged along: a plurality of first axes substantially parallel to a long edge of the top plate; and a plurality of second axes substantially parallel to a short edge of the top plate, and wherein each of the first axes and the second axes are substantially aligned with a diameter of a subset of well openings of the plurality of well openings.

In an aspect the technology relates to a temperature regulation system for regulating a temperature of samples in a microplate. The temperature regulation system including a plurality of electromagnets disposed in an array and configured to receive each well of a microplate between a subgroup of plurality of electromagnets. The temperature regulation system including a base plate supporting the plurality of electromagnets, wherein the base plate includes a plurality of airflow ports arranged about the supported electromagnets.

In some aspects, the base further includes thermal fluid passage ways to allow flow of a thermal fluid through the base plate to regulate a temperature of the base plate and/or regulate a temperature of air passing through the plurality of air flow ports.

### BRIEF DESCRIPTION OF THE DRAWINGS

FIGS. 1A and 1B depict top perspective and bottom views, respectively, of a vented microplate.

FIGS. 2A-2C depict perspective, exploded perspective, and cross-sectional views, respectively, of an electromagnetic mixing and temperature regulation system.

FIG. 3 depicts a cross-sectional view of an electromagnetic mixing and temperature regulation system, in accordance with another example.

FIG. 4 depicts a method of regulating sample temperatures in a microplate.

FIG. 5 depicts an example of a suitable operating environment in which one or more of the present examples can be implemented.

FIG. 6 depicts a top perspective view of another example of a vented microplate.

FIG. 7 depicts a top perspective view of another example of a vented microplate.

### DETAILED DESCRIPTION

Electromagnetic mixing systems are described, for example, in PCT International Publication No. WO 2017/093896, entitled “Electromagnetic Assemblies for Processing Fluids,” the disclosure of which is hereby incorporated by reference herein in its entirety. In general, electromagnetic mixing systems include a number of electromagnetic structures disposed around a sample container, such as a standalone vial or an individual well of a microplate that contains a liquid sample. The structures are activated in a prescribed manner, so as to generate a changing magnetic field within the sample container. This changing magnetic field causes magnets disposed within the sample container to circulate, which aids in mixing and other reactions within the liquid sample. Processes that utilize magnetic bead mixing are well known in the art. One significant effect of the activation of the electromagnetic structures is the generation of heat therefrom. It is desirable to dissipate this heat so as to maintain an appropriate temperature of the sample. This ensures the ability to perform analysis of certain analytes, ensures reproducibility of results, maintains the integrity of the sample, preserves reaction kinetics, etc. Other examples of magnetic mixing systems are described in PCT International Publication Nos. WO 2015/128725, WO 2019/102355, and WO 2021/203005, the disclosures of which are hereby incorporated by reference herein in their entireties.

In general, a microplate (also referred to as a well tray, sample plate, well plate, microwell plate, multiwell, etc.) is a flat plate with multiple “wells” used as small test tubes. The microplate has become a standard tool in analytical research and clinical diagnostic testing laboratories. Example microplates typically have 6, 12, 24, 48, 96, 384 or 1536 sample wells arranged, e.g., in a 2:3 rectangular matrix. Each well of a microplate typically holds between tens of nanolitres to several millilitres of liquid samples. They can also be used to store dry powder or as racks to support glass tube inserts.

A magnetic mixer, Beckman EMnetik 24 system, was recently introduced to improve the efficiency and speed of handling samples being processed with paramagnetic beads. The EMnetik 24 system provides for an array of electromagnetic drive coils which are situated about each well of a sample well plate and are operable to generate varying electromagnetic fields within each well to mix the beads within the well and/or to separate the beads from the mixture in the well. These and further features of the EMnetik 24 system are described in EMnetik Plasmid Purification System Protocol, Beckman Coulter, Inc. November 2021, the disclosure of which is hereby incorporated by reference herein in its entirety. The EMnetik 24 system controls the excess heat generated by the coils using fans to direct air in a cross-flow pattern, through the array of coils to provide convective cooling of the coils. The EMnetik 24 system employs a cross-flow airflow that is orthogonal to the spindle axis orientation. As the airflow passes through the electromagnets of the EMnetik 24 system, it picks up additional heat such that it has an increasing temperature as it passes through the array of electromagnets, providing a reduced cooling effect to the electromagnets as it progresses. As such, this arrangement is sufficient to moderate the heat generation for small numbers of coils and certain applications.

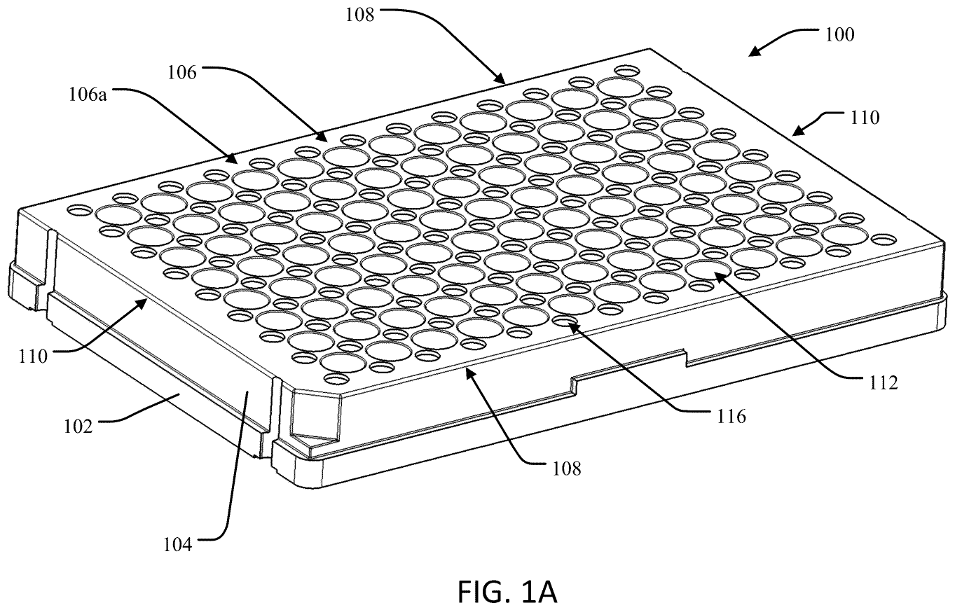

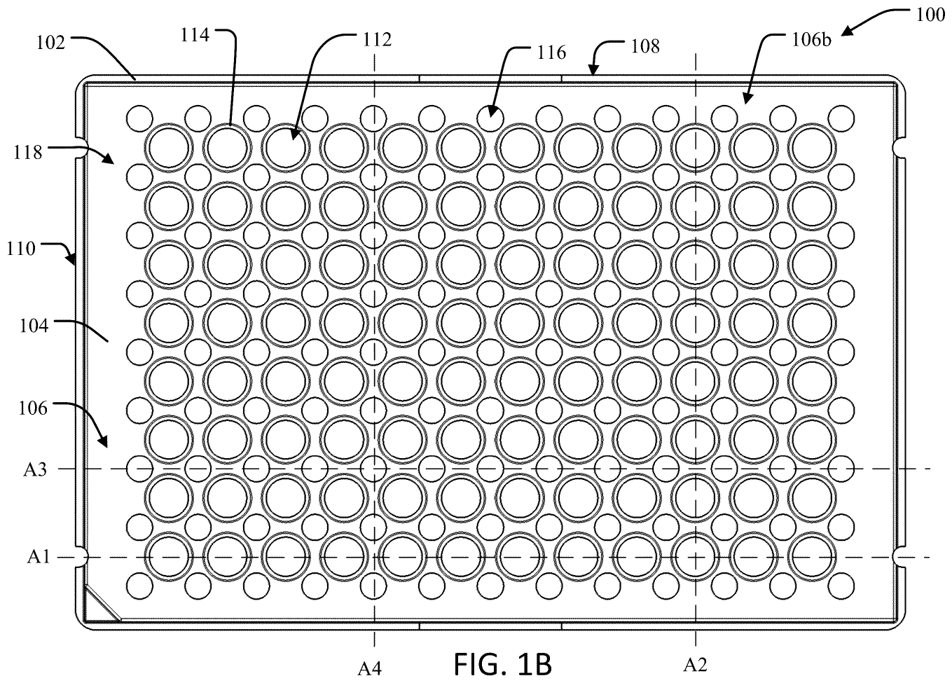

FIGS. 1A and 1B depicts top perspective and bottom views, respectively, of a vented microplate 100. FIGS. 1A and 1B are described concurrently and not every feature described is depicted in both figures. The microplate 100 includes a base or rim 102 that might project slightly away from or be coextensive with a body 104 of the microplate 100. The microplate 100 includes a top plate 106 bounded by edges, referred to herein as long edges 108 and short edges 110. The top plate 106 has an upper surface 106a and a lower surface 106b and a defined thickness. The upper surface 106a defines a plurality of openings, more specifically, well openings 112. A well wall 114 extends downward from the lower surface 106b, thus forming a well into which a sample may be received. In examples, the well wall 114 is integrally formed with the top plate 106. An optically or acoustically transparent base (not shown) may be secured to each well wall 114 so as to close a lower portion of each well. In examples, the base may be integrally formed with the well wall 114, or may be discretely manufactured and secured via an adhesive or mechanical fastener (e.g., a snap-fit connection). Both the upper surface 106a and the lower surface 106b define a plurality of openings, namely, airflow openings 116, which are configured as through-holes through the top plate 106. In examples, the well openings 112 are of a uniform diameter that is greater than a diameter of the airflow openings 116, though other configurations are contemplated.

In examples, the well openings 112 may have an open mouth defined by an outer raised rim or may be flush with the upper surface 106a of the top plate 106. The well walls 114 may be generally cylindrical, conical, or frustoconical in shape. In other examples, the well walls 114 may be straight and the base of each well may be curved, concave, or flat. Different configurations and form factors of wells are known in the art; particular configurations or form factors are not necessarily relevant to the present technology. However, when used in contactless ejection applications, it may be desirable that the base of each well may be flat. The well walls 114 project downward from the top plate 106 into a substantially hollow interior 118 of the microplate 100, which is defined in part by the base 102 or body 104 and top plate 106 of the microplate 100. This substantially hollow interior 118 helps improve airflow and heat dissipation, as opposed to a microplate formed from a relatively thick piece of solid material with wells and other openings formed therethrough or therein.

Subsets of the well openings 112 are arranged in parallel rows and parallel columns as are subsets of the airflow openings 116. In the depicted example, pluralities of well openings 112 are arranged along a plurality of first axes (a single one of the first axes is represented by axis A1 in FIG. 1B) that are each substantially parallel to the long edges 108 of the top plate 106. Further, pluralities of well openings 112 are arranged along a plurality of second axes (a single one of the second axes is represented by axis A2) that are each substantially parallel to the short edges 110 of the top plate 106. The axes A1 and A2 are aligned substantially with a diameter of each well opening 112 in a particular row or column. Similarly, pluralities of airflow openings 116 are arranged along a plurality of third axes (a single one of the third axes is represented by axis A3) that are each substantially parallel to the long edges 108 of the top plate 106. Further, pluralities of airflow openings 116 are arranged along a plurality of fourth axes (a single one of the fourth axes is represented by axis A4) that are each substantially parallel to the short edges 110 of the top plate 106. The axes A3 and A4 are aligned substantially with a diameter of each airflow opening 116 in a particular row or column. In view of this configuration, axes A1 and A3 are substantially parallel, as are axes A2 and A4. Given the configuration of the plate edges 108, 110, axes A1 and A3 are substantially orthogonal to axes A2 and A4. By arranging pluralities of well openings 112 on axes parallel to those of pluralities of airflow openings 116, a greater density of openings may be achieved in a given microplate 100. Further, this configuration allows the airflow openings 116 to be arranged so as to be aligned with electromatic structures in an electromagnetic mixing system, as described in more detail below. Other configurations of well openings and airflow openings are also contemplated. For example, well openings 112 and airflow openings 116 may be arranged on a single axis (in either or both of rows or columns).

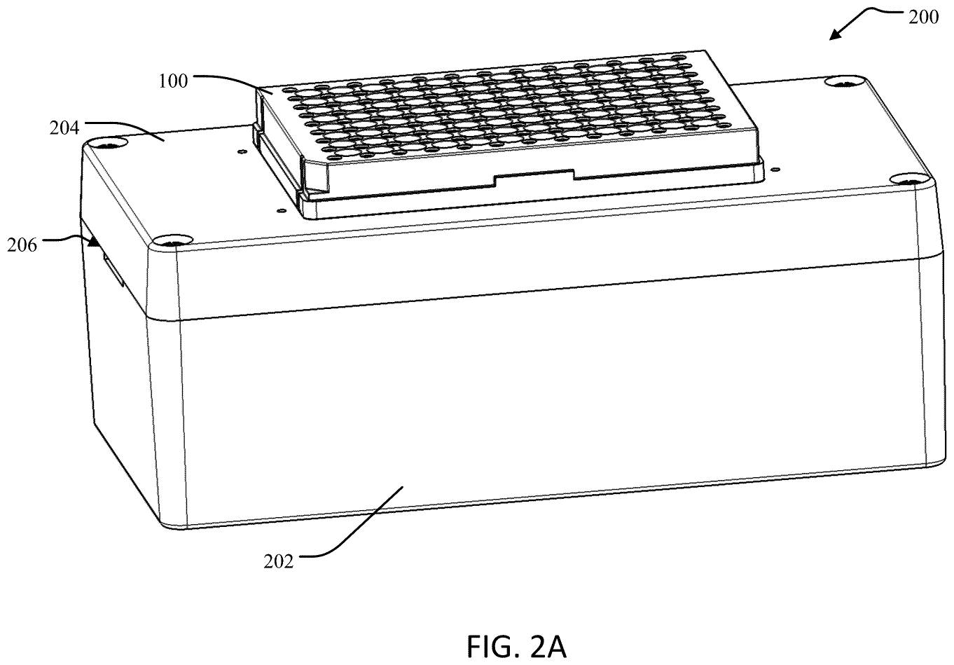

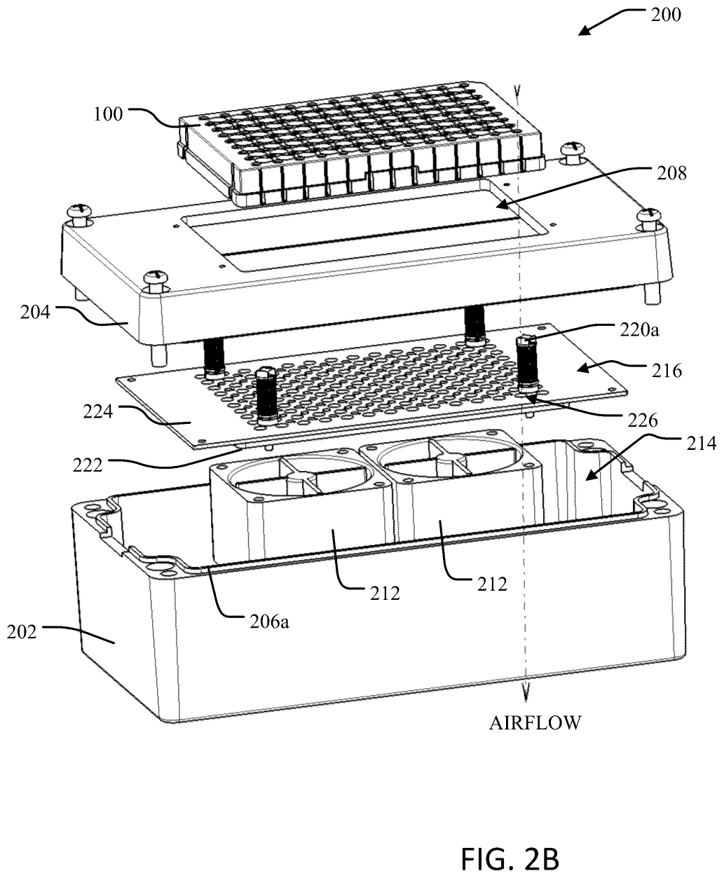

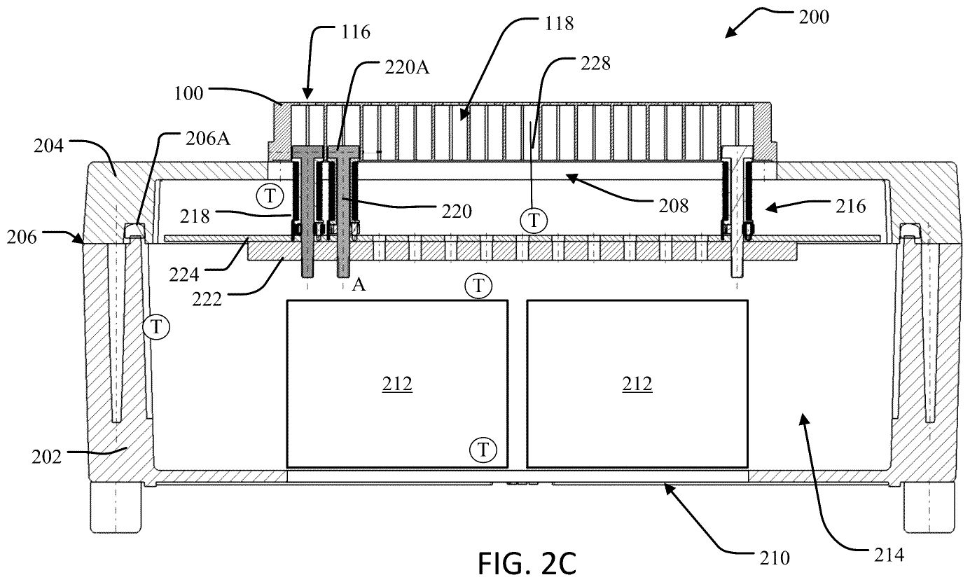

FIGS. 2A-2C depict perspective, exploded perspective, and cross-sectional views, respectively, of an electromagnetic mixing and temperature regulation system 200. FIGS. 2A-2C are described concurrently and not every feature described is depicted in all figures. The mixing and temperature regulation system 200 is used in conjunction with a vented microplate 100, such as depicted and described in FIGS. 1A and 1B. The system 200 may be a self-contained unit suitable for tabletop use, or may be incorporated into an automated microplate analysis, storage, and/or processing system. The unit may be operated on battery power or may be powered by via a standard plug to a building power supply or may be powered as part of a larger system. In the following figures, power sources, drivers for the electromagnetic mixing system, all electromagnetic coils, fan motors, etc., are not depicted, but would be apparent to a person of skill in the art.

The system 200 includes a housing having a base 202 and a lid 204, which may be joined at an interface 206. The interface 206 may be configured so as to form an airtight seal between the base 202 and the lid 204. Such a configuration may include one or more mating features, gaskets, or other structures 206a. Each of the base 202 and the lid 204 include a plurality of outer surfaces, one or more of which may define one or more airflow ports. For example, the lid 204 may define an airflow port 208 which may be sized and configured to mate with a vented microplate 100, such as depicted elsewhere herein. The base 202 defines an airflow port 210 which, in the depicted configuration, is disposed below a pair of fans 212. The airflow ports 208, 210 allow for airflow into and out of an interior volume 214 of the housing, as described herein. In one example, air is drawn through the airflow port 208 by the fans 212 and ejected from the airflow port 212. In another example, the fan direction and therefor airflow is reversed. In the depicted example, axial fans are used but other types are contemplated. Further, a single fan or more than one fan may be utilized. Airflow ports on different surfaces of the housing may require changes in fan configuration, airflow port location, fan type, fan control, or fan static pressure requirements, but such modifications would be readily apparent to a person of skill in the art. The interior volume 214 provides space for driver(s) for an electromagnetic mixing system 216, power source, cabling and control wiring, sensors, etc.

The electromagnetic mixing system 216 includes a number of electromagnets 218, which may be of a known construction, e.g., a coil of wire around a spindle 220 of ferromagnetic material. A head 220a of each spindle 220 projects upward and out of the airflow port 208, so as to project into the substantially hollow interior 118 of the microplate 100. While only some of the electromagnets 218 are depicted for illustrative purposes, the electromagnetic mixing system 216 would include a number of electromagnets 218 to substantially surround each well of the microplate 100 to ensure proper mixing functionality. With regard to the system 200 depicted in FIGS. 2A-2C, the head 220a of each spindle 220 is disposed substantially below each airflow opening 116 in the microplate 100 to ensure relatively unimpeded airflow along the well walls 114. The electromagnets 218 each define an axis A that extends upward from a base plate 222 and a PCB 224 supported thereon. The base plate 222 may be secured to the housing, e.g., proximate the interface 206, and is utilized to support the weight of the electromagnetic mixing system 216. Both the base plate 222 and the PCB 224 are perforated or otherwise define a plurality of openings (depicted generally at 226) therethrough to enable airflow. These openings are generally arranged between the electromagnets 218. In another example, robust screen or mesh may be used in the alternative to the base plate 222. Given the configuration of the airflow openings 116, airflow port 208, openings 226 (in the base plate 222 and the PCB 224), fans 212, and airflow port 210, airflow may be considered to be generally vertical, routed along the well walls 114 and substantially aligned axially with the axes A of each spindle 220 of each electromagnet 218. This airflow direction helps maintain a consistent temperature gradient across the entire microplate 100 as the air exits the openings 226 with a common temperature to flow past the electromagnets 218.

A plurality of example locations for temperature sensors T are depicted, though not all need to be utilized. The temperature sensor T may be integrated with a controller for the fan(s), a controller for the electromagnetic system 216, or may be a stand-alone temperature sensor disposed remote from other components. In another example, the temperature sensor may be integrated with a power circuit for the fan(s) to activate the fan(s) based on a predetermined temperature being reached. Temperature sensor T may be located on an interior of the housing, proximate a fan inlet or outlet, proximate an airflow port 208, 210 in the housing, or within the components of the electromagnetic mixing system (where the temperature may be most likely to be elevated). A temperature sensor T may be configured to extend partially or completely into the hollow interior 118 of the microplate 100 to detect a temperature therein. Such a temperature sensor T is depicted generally at 228. Fan control may be driven by a signal sent from the temperature sensor T, causing both fans to operate simultaneously, or in stages, as required or desired for particular application. In other examples, the fans may be powered when the electromagnetic mixing system 216 is powered and/or may be set to run on a timer so as to speed cooling of the electromagnets after they have been deenergized.

The configuration of a temperature regulation system 200 such as depicted in FIGS. 2A-2C is often sufficient to maintain samples in a microplate 100 at or near an ambient temperature. Ambient air may be drawn in through the airflow openings in the microplate 100, while heat generated by the electromagnetic mixing system, fan(s), and any other components within the housing may be discharged out of the system. In some examples, it may be acceptable to utilize a “blow through” configuration, where ambient air is first drawn into the housing, then discharged out of the upper airflow port 208 and through the airflow openings 116 in the microplate 100. Such a flow configuration may be acceptable if the ambient temperature is lower (e.g., in an actively cooled room desirable for specific processing). It may also be desirable to actively lower the temperature of ambient air.

In some embodiments, the temperature regulation system 200 may include a plurality of separate airflow passages. Each airflow passage connected to a subgroup of the upper airflow ports 208. The system 200 may include a plurality of fans and/or temperature regulation elements such that the airflow rate and/or temperature may be separately controlled for each airflow passage. For example, a central subgroup of upper airflow ports 208 in a center of the array of electromagnets 218, may be supplied with cooler air and/or at a higher flow rate, then a peripheral subgroup, or subgroups, of airflow ports 208. This arrangement allows for differential cooling rates across the microplate in cases where a center of the array of electromagnets 218 may present a higher temperature profile than a periphery of the array of electromagnets 218.

In some aspects, the flow of air through the separate airflow passages may be controlled based on empirical observation, for instance a higher cooling rate on the order of a predetermined, desired, or required percentage for a central subgroup of airflow ports 208 is required to maintain a flat temperature profile across a microplate when the system 200 is in operation. In some aspects, the flow of air through the separate airflow passages may be controlled based on active control, with separate temperature sensors provided at different locations about the array of electromagnets 218 to measure a temperature of the structure, or the airflow after passing through the electromagnets 218, and to adjust at least one of an airflow rate and/or air temperature of air flowing through one or more of the airflow passages based on the measured temperature(s).

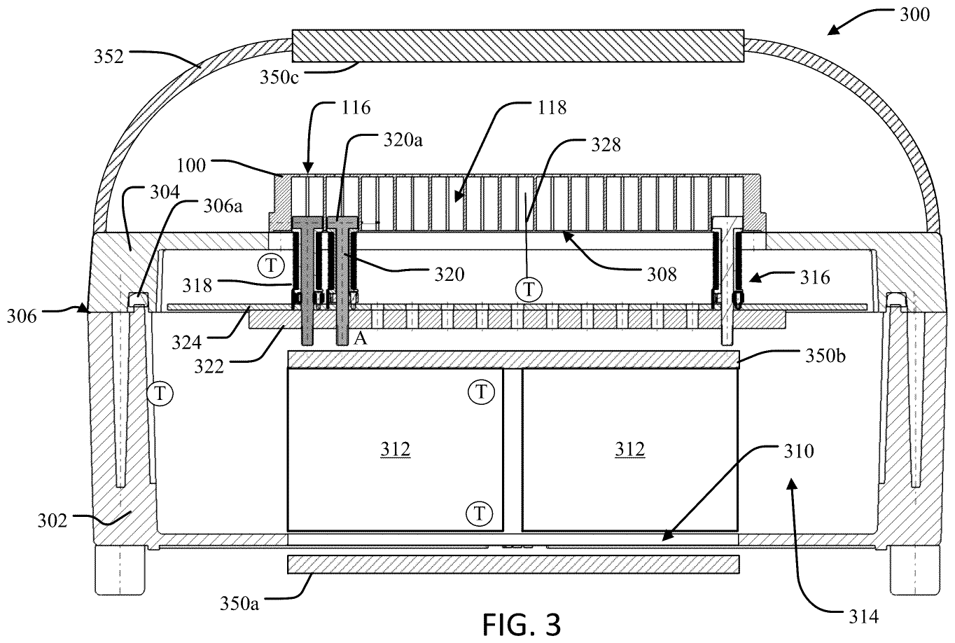

In that regard, FIG. 3 depicts a cross-sectional view of an electromagnetic mixing and temperature regulation system 300, in accordance with another example. A number of features depicted in FIG. 3 have already been described in the context of FIG. 2C and include similar numbering thereto, but begin with “300.” Certain of those elements are not described further. Notably, the system 300 of FIG. 3 depicts multiple locations where temperature regulation elements 350 may be utilized. In examples, the temperature regulation elements 350 may be located in one or more of the depicted locations. In some embodiments, the temperature regulation element 350 may be a cooling coil, such as a chilled water coil or other coil that circulates a thermal fluid such as a refrigerant. Peltier cooling units may also be used. In some embodiments, the temperature regulation element 350 may be operative to provide either a cooling or a heating function in order to provide a desired temperature regulation for a given application and heat generation by the electromagnets. Three example locations of temperature regulation locations are depicted, though other locations are contemplated.

In FIG. 3, the thermal regulation element 350 is illustrated as a cooling coil 350a disposed proximate an airflow port 310, where it cools air being drawn into fans 312 via the airflow port 310 before being blown upward through the electromagnetic cooling system 316 and through the microplate 100. In another example, cooling coil 350a may be disposed within an interior of the mixing and cooling system 300, e.g., below the fans 312. Cooling coil 350b may be disposed at a discharge of the fans 312, delivering cool air upward through the electromagnetic cooling system 316 and through the microplate 100. In another example, cooling coil 350c may be disposed on a removable lid 352 which may be removed in order to place the microplate 100 as depicted. The lid 352 may then be replaced. In this configuration, the fans 312 operate in a reverse airflow direction than that required when the cooling coils 350a or 350b are utilized. Ambient air is drawn through the cooling coil 350c and into the space defined by the lid 352, prior to being drawn into the airflow openings 116 on the microplate 100 and ultimately out via the lower airflow port 310.

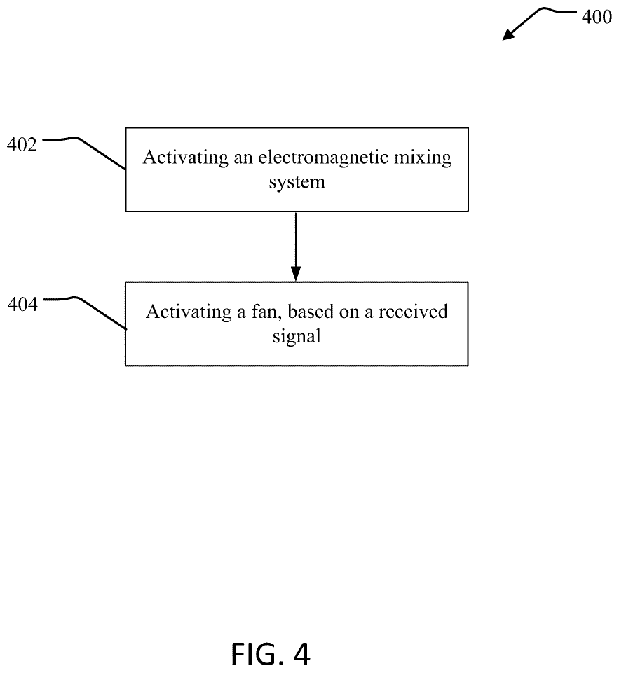

FIG. 4 depicts a method 400 of cooling samples in a microplate. A method of may be performed with the vented microplate 100 described herein, and used in conjunction with an electromagnetic mixing and cooling system 200 such as that depicted in FIGS. 2A-2C, or variations thereof. As such, the system that performs the method 400 may include a base plate defining a plurality of openings and a plurality of electromagnets. Each electromagnet defines an axis that extends substantially vertically from the base plate. The base plate is disposed in an interior volume of a housing, which defines a first airflow port and a second airflow port. The plurality of electromagnets extend towards and through the first airflow port. The method 400 begins with operation 402, activating the electromagnetic mixing system. The method 400 also includes operation 404, activating a fan, based on a received signal. The fan is disposed in the interior volume substantially below the base plate. By activating the fan, air is drawn into one of the first airflow port and the second airflow port, substantially parallel to each axis of the plurality of electromagnets, through the plurality of openings, and out of the other of the second airflow port and the first airflow port. In examples, the received signal is a control signal for the electromagnetic mixing system, such that when the electromagnetic mixing system is energized, the fan is also energized. In another example, the received signal is a signal from a temperature sensor, such as disclosed herein. Further, multiple signals may be received by a controller associated with the cooling system, enabling multi-stage fan activation, or variable speed fan activation, as required for particular applications.

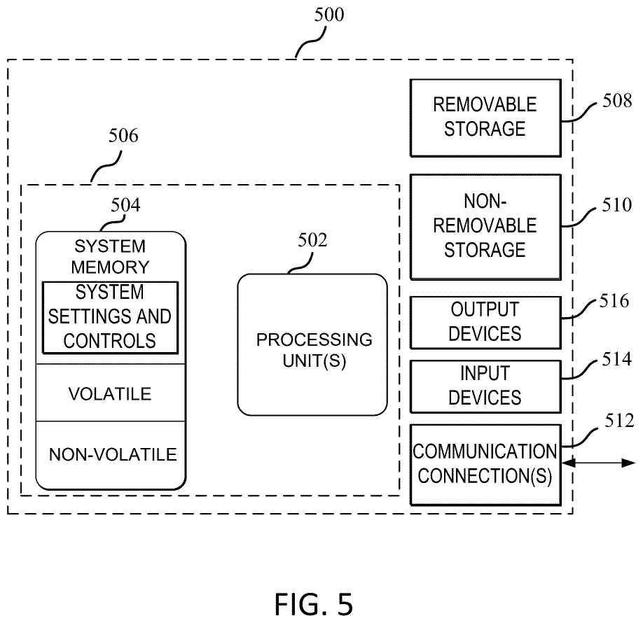

FIG. 5 depicts one example of a suitable operating environment 500 in which one or more of the present examples can be implemented. This operating environment may be incorporated directly into a controller for an electromagnetic mixing system (e.g., a tabletop mixing and temperature regulation system as described above), or into a fan controller that may be incorporated into such a system. In examples where such a system is incorporated into a microplate analysis, processing, and/or storage system, the operating environment may be incorporated directly into such a system. These are only some examples of suitable operating environments and are not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like. Such computing systems may be used to directly control one or more processes or components of a microanalysis system.

In its most basic configuration, operating environment 500 typically includes at least one processing unit 502 and memory 504. Depending on the exact configuration and type of computing device, memory 504 (storing, among other things, instructions to control the electromagnetic mixing, control the fan(s), interpret signals from temperature or other sensors, or perform other methods disclosed herein) can be volatile (such as RAM), non-volatile (such as ROM, flash memory, etc.), or some combination of the two. This most basic configuration is illustrated in FIG. 5 by dashed line 506. Further, environment 500 can also include storage devices (removable, 508, and/or non-removable, 510) including, but not limited to, magnetic or optical disks or tape. Similarly, environment 500 can also have input device(s) 514 such as touch screens, keyboard, mouse, pen, voice input, etc., and/or output device(s) 516 such as a display, speakers, printer, etc. Also included in the environment can be one or more communication connections 512, such as LAN, WAN, point to point, Bluetooth, RF, etc.

Operating environment 500 typically includes at least some form of computer readable media. Computer readable media can be any available media that can be accessed by processing unit 502 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 500 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 500 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 500 is part of a network that stores data in remote storage media for use by the computer system 500.

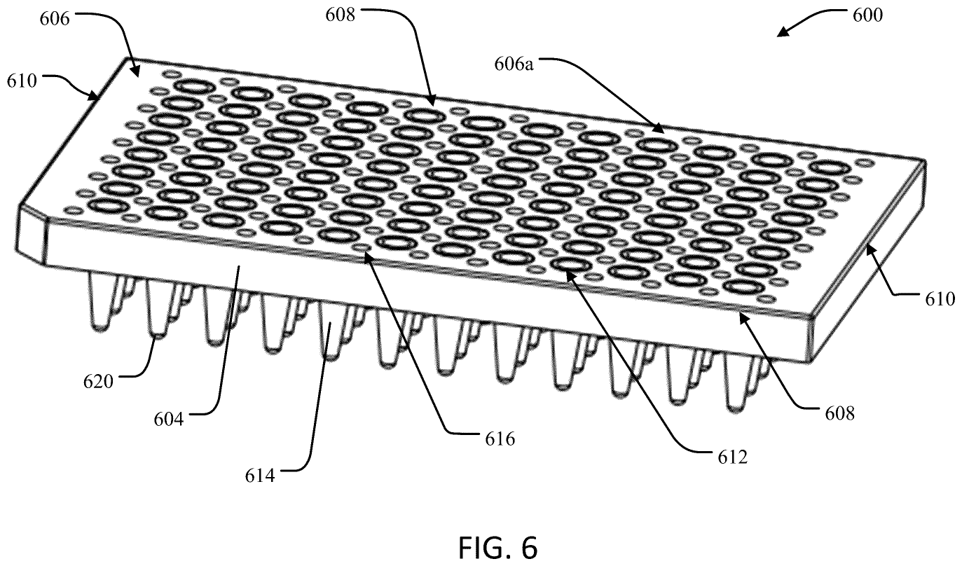

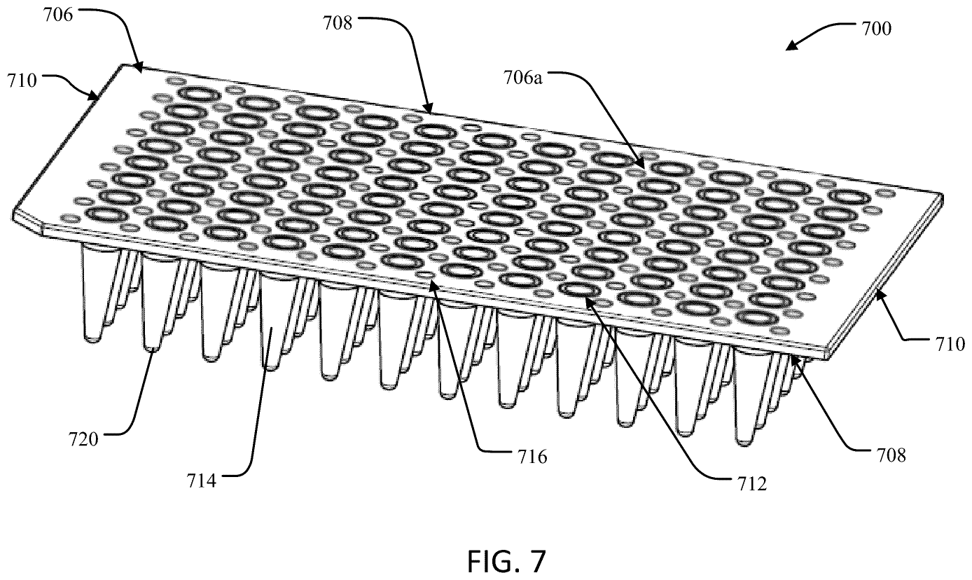

The temperature regulation systems described herein may be utilized with microplates having other configurations as well. Other such microplates are depicted below in FIGS. 6 and 7. In general, these microplates 600, 700 both utilize airflow openings 616, 716 as described above in the context of the microplate 100 of FIGS. 1A and 1B. However, these microplates 600, 700 also allow for airflow through the outer perimeter thereof, due in part to the presence of a partial-height base, or an absence of a base entirely, as described in more detail below. As such, airflow may also flow via the sides of the microplates 600, 700 described in FIGS. 6 and 7. As such, microplates characterized by a partial-height base or absent base may also be utilized with the temperature regulation systems described herein and display adequate performance for certain applications.

FIG. 6 depicts a top perspective view of another example of a vented microplate 600. The microplate 600 includes a partial-height body 604 that extends down from a top plate 606 of the microplate 600. The top plate 606 is bounded by edges, referred to herein as long edges 608 and short edges 610. The top plate 606 has an upper surface 606a and a lower surface (not shown) and a defined thickness. The upper surface 606a defines a plurality of openings, more specifically, well openings 612. A well wall 614 extends downward from the lower surface 606b, thus forming a well into which a sample may be received. In examples, the well wall is integrally formed with the top plate 606. An optically or acoustically transparent base 620 may be secured to each well wall 614 so as to close a lower portion of each well. Given the partial-height of the body 604, when used in conjunction with the thermal regulation systems described herein, the microplate 600 may rest on bases 620 of each well. In examples, the base may be integrally formed with the well wall 614, or may be discretely manufactured and secured via an adhesive or mechanical fastener (e.g., a snap-fit connection). Both the upper surface 606a and the lower surface define a plurality of openings, namely, airflow openings 616, which are configured as through-holes through the top plate 606. In examples, the well openings 612 are of a uniform diameter that is greater than a diameter of the airflow openings 616, though other configurations are contemplated. Further features of the microplate 600 are described above in the context of microplate 100, e.g., as relates to alignment of the various openings, number of openings, materials, shape of wells, shape of openings, etc., and would be apparent to a person of skill in the art.

FIG. 7 depicts a top perspective view of another example of a vented microplate 700. The microplate 700 is characterized by an absence of a body surrounding the edges of a top plate 706, referred to herein as long edges 708 and short edges 710. The top plate 706 has an upper surface 706a and a lower surface (not shown) and a defined thickness. The upper surface 706a defines a plurality of openings, more specifically, well openings 712. A well wall 714 extends downward from the lower surface 706b, thus forming a well into which a sample may be received. In examples, the well wall is integrally formed with the top plate 706. An optically or acoustically transparent base 720 may be secured to each well wall 714 so as to close a lower portion of each well. Given the absence of a body around the wells, when used in conjunction with the thermal regulation systems described herein, the microplate 700 may rest on bases 720 of each well. In examples, the base may be integrally formed with the well wall 714, or may be discretely manufactured and secured via an adhesive or mechanical fastener (e.g., a snap-fit connection). Both the upper surface 706a and the lower surface define a plurality of openings, namely, airflow openings 716, which are configured as through-holes through the top plate 706. In examples, the well openings 712 are of a uniform diameter that is greater than a diameter of the airflow openings 716, though other configurations are contemplated. Further features of the microplate 700 are described above in the context of microplate 100, e.g., as relates to alignment of the various openings, number of openings, materials, shape of wells, shape of openings, etc., and would be apparent to a person of skill in the art.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A temperature regulation system for samples in a microplate, the temperature regulation system comprising:
a housing defining an interior volume, a first airflow port defined by a first exterior surface of the housing, and a second airflow port defined by a second exterior surface of the housing;
an electromagnetic mixing system comprising:
a base plate defining a plurality of openings; and
a plurality of electromagnets each defining an axis and extending substantially vertically from the base plate, wherein the base plate is disposed in the interior volume and wherein each of the plurality of electromagnets extend toward the first airflow port; and
a fan disposed in the interior volume substantially below the base plate, wherein activation of the fan draws air into one of the first airflow port and the second airflow port, substantially parallel to each axis of the plurality of electromagnets, through the plurality of openings, and out of the other of the second airflow port and the first airflow port.

2. The temperature regulation system of claim 1, wherein at least a portion of each of the plurality of electromagnets extends through the first airflow opening.

3. The temperature regulation system of claim 1, wherein the housing comprises a base and a lid, wherein the first airflow port is defined by the lid.

4. The temperature regulation system of claim 3, wherein the second airflow port is defined by the base.

5. The temperature regulation system of claim 1, wherein the first airflow port, the plurality of electromagnets, the fan, and the second airflow port are substantially vertically aligned.

6. The temperature regulation system of claim 3, wherein the base plate is secured to at least one of the base and the lid.

7. The temperature regulation system of claim 3, wherein an interface between the base and the lid comprises an airtight connection.

8. The temperature regulation system of claim 1, further comprising a controller coupled to the fan and the plurality of electromagnets.

9. The temperature regulation system of claim 8, further comprising a sensor coupled to the controller, where the controller is configured to activate the fan based on a signal received from the sensor.

10. The temperature regulation system of claim 1, further comprising a cooling coil secured to the housing.

11. A microplate comprising:
a top plate comprising an upper surface and a lower surface, wherein:
the upper surface defines a plurality of well openings, wherein each well opening of the plurality of well openings is connected to a sample well extending from the lower surface; and
the upper surface and the lower surface both define a plurality of airflow openings through the top surface.

12. The microplate of claim 11, wherein the plurality of well openings are arranged along:
a plurality of first axes substantially parallel to a long edge of the top plate; and
a plurality of second axes substantially parallel to a short edge of the top plate, and wherein each of the first axes and the second axes are substantially aligned with a diameter of a subset of well openings of the plurality of well openings.

13. The microplate of claim 12, wherein the plurality of airflow openings are arranged along:
a plurality of third axes substantially parallel to a long edge of the top plate; and
a plurality of fourth axes substantially parallel to a short edge of the top plate, and wherein each of the third axes and the fourth axes are substantially aligned with a diameter of a subset of airflow openings of the plurality of airflow openings.

14. The microplate of claim 13, wherein the plurality of first axes are parallel to the plurality of third axes and wherein the plurality of second axes are parallel to the plurality of fourth axes.

15. The microplate of claim 11, wherein each of the plurality of well openings comprise a diameter larger than each of the plurality of airflow openings.

16. The microplate of claim 11, wherein each sample well extends into a substantially hollow interior of the microplate.

17. A method of regulating a temperature of samples in a microplate, the method comprising:
activating an electromagnetic mixing system comprising:
a base plate defining a plurality of openings; and
a plurality of electromagnets each defining an axis and extending substantially vertically from the base plate, wherein the base plate is disposed in an interior volume of a housing, wherein the housing defines a first airflow port and a second airflow port, and wherein each of the plurality of electromagnets extend toward the first airflow port; and
activating, based on a received signal, a fan disposed in the interior volume substantially below the base plate, wherein activation of the fan draws air into one of the first airflow port and the second airflow port, substantially parallel to each axis of the plurality of electromagnets, through the plurality of openings, and out of the other of the second airflow port and the first airflow port.

18. The method of claim 17, wherein the received signal comprises a control signal for the electromagnetic mixing system.

19. The method of claim 17, wherein the received signal comprises a signal from a temperature sensor.

20. The method of claim 17, wherein the first airflow port is defined by a first exterior surface of the housing, and the second airflow port is defined by a second exterior surface of the housing.
